(19) United States
(12) Patent Application Publication
(10) Pub. No.: US 2006/0253686 A1
(43) Pub. Date: Nov. 9, 2006

(54) Instruction prefetch apparatus and instruction prefetch method

(75) Inventor: Hitoshi Suzuki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/484,601

(22) Filed: Jul. 12, 2006

(30) Foreign Application Priority Data
Mar. 8, 2005 (JP) 2005-224977

(51) Int. Cl. G06F 9/30

(52) U.S. Cl. 712/207

(57) ABSTRACT

The processor system includes an instruction cache for storing a prefetched instruction, an instruction execution section for executing the instruction stored in the instruction cache, a branch target address register for storing the address of the branch target instruction, a register write detector for detecting writing to the branch target address register by the instruction execution section, and a prefetch controller for starting prefetch of the branch target instruction in response to a detection result of the register write detector.

### BACKGROUND OF THE INVENTION

1. Field of the Invention

The present invention generally relates to instruction prefetch that gets an instruction prior to the execution of the instruction and particularly relates to an instruction prefetch apparatus and prefetch method that prefetches a branch target instruction to be executed after branch instruction.

2. Description of Related Art

In order to improve the processing performance of a processor, it is important to feed instructions to an instruction execution section that executes the instruction without delay. To achieve the feeding without delay, a technique which copies the instruction predicted to be executed from a memory area storing instructions such as an external main memory to a memory area capable of high-speed access such as an instruction cache prior to the instruction fetch stage is known. This technique enables improvement in hit rate of the instruction cache. Another technique for achieving the feeding without delay is the one which places an instruction queue (FIFO) between the instruction decoding stage and the execution stage and always keeps the decoded instructions in the instruction queue.

It is noted in the following description that a technique which loads the instruction to be executed in advance to a primary storage area such as an instruction cache and an instruction queue (referred to herein as the instruction buffer) for the purpose of preventing the feeding of instructions to the instruction execution section from stopping is referred to collectively as the “prefetch technique”.

Because branch instructions exist in an instruction sequence which is executed in the instruction execution section, the instructions are not necessarily executed in the order of address but can be branched to a discontinuous address. The branch instruction means the instructions which change the instruction address to be executed next by updating the value of a program counter. Specifically, the branch instructions include unconditional branch instruction such as return instruction from interrupt or exception handling and conditional branch instruction which accompanies conditional test. In a broad sense, the branch instructions may include task dispatching by an operating system (referred to herein as the multitasking OS) that executes in parallel a plurality of tasks or processes in terms of discontinuous update of program counter values. If the branch instruction exists in an instruction sequence, cache miss is likely to occur during the fetch of a branch target instruction even with the prefetch of the instruction which is stored following the branch instruction in a main memory.

For the effective prefetch on the instruction sequence which includes the branch instruction, there are known a technique which starts the prefetch of the branch target instruction if the fetched instruction is the unconditional branch instruction, and a technique which predecodes the prefetched instruction and starts the prefetch of the branch target instruction if the fetched instruction is the unconditional branch instruction as disclosed in Japanese Unexamined Patent Publication No. 8-272610, for example. The is also known a technique which predicts the direction of the branch in addition to detecting the branch instruction and prefetches the instruction on a predicted branch address as disclosed in Japanese Unexamined Patent Publication No. 2003-76609, for example.

FIG. 6 shows an exemplary structure of a processor system 7 according to a related art, which includes an instruction execution section such as CPU and an instruction cache. An instruction execution section 11 is a processor which fetches an instruction from an instruction cache 14 or an ROM 19 and executes the instruction. A program counter 12 stores the address of the instruction which is executed in the instruction execution section 11. The value of the program counter 12 is updated by the instruction execution section 11. If the instruction is executed sequentially, the value of the program counter 12 is updated in increments of the value corresponding to the instruction length. If the branch instruction exists, the value is updated discontinuously according to the address of the branch target instruction.

A branch target address register 17 stores the address of a branch target instruction, and it is used when designating the storage destination of the branch target instruction by register indirect addressing. The storage to the branch target address register 17 is done by the control of the instruction execution section 11. The value which is stored in the branch target address register 17 is designated as a branch target instruction address explicitly or implicitly by the branch instruction which is executed later.

The register indirect addressing is the addressing method which designates the location to store data on a memory by the address value that is stored in a register. This method may be used for the case which cannot directly designate an address in an operand of the instruction such as when designating 32-bit address by 32-bit instruction and the case which requires the calculation of the address to refer, for example.

The branch target address register 17 may be placed as a dedicated register for storing a branch target instruction address or may be specified by a compiler from a general-purpose register used by the instruction execution section 11.

Specifically, the branch target address register 17 includes (1) a register that stores the address of a return target instruction when returning from interrupt or exception handling, (2) a register that stores the entry address of the task which is dispatched by the multitasking OS, (3) a register which is specified by a compiler as a base register in designating the branch target instruction address by register indirect addressing when returning from software interrupt, calling the function, returning from the function, and so on.

A prefetch controller 73 controls the instruction prefetch from an external memory 15 to the instruction cache 14. In normal cases, the prefetch controller 73 prefetches the instructions sequentially from the address which adds an instruction length to the value of the program counter 12. If the program to be executed in the instruction execution section 11 explicitly contains the instruction for the prefetch of a branch target instruction, the prefetch controller 73 prefetches the branch target instruction according to the prefetch designation by the instruction execution section 11. Further, the prefetch controller 73 prefetches the branch target instruction according to the prefetch designation by a branch detector 16.

The branch detector 16 detects whether the instruction which is fetched from the instruction cache 14 by the instruction execution section 11 is branch instruction or not. Upon detection of the branch instruction, the branch detector 16 directs the prefetch controller 73 to prefetch the branch target instruction. Alternatively, the branch detector 16 may predecode the prefetched instruction to detect the branch instruction instantaneously, as disclosed in Japanese Unexamined Patent Publication No. 8-272610.

In this configuration, the processor system 7 of the related art can refill the instructions to be executed by the instruction execution section 11 from the low-speed external memory 15 to the high-speed instruction cache 14.

However, the present invention has recognized that the instruction prefetch processing in the above-descried processor system 7 cannot start the prefetch of the branch target instruction at least until the branch instruction is detected in the predecoding after the instruction prefetch. This causes the prefetch of the branch target instruction to be not in time for the fetch or execution of the branch target instruction by the instruction execution section 11. The suspension of the feeding of the instructions to the instruction execution section 11 is thus likely to occur in this system.

The execution of the branch instruction and the branch target instruction by the processor system 7 is described hereinafter with reference to FIG. 7. In Step S201, the prefetch controller 73 refills the branch instruction to the instruction cache 14 according to the value of the program counter 12. In Step S202, the instruction execution section 11 fetches the branch instruction from the instruction cache 14 and executes the fetched branch instruction. In Step S203, the branch detector 16 detects the presence of the branch instruction from the transfer data during the fetch of the branch instruction by the instruction execution section 11 and notices the address of the branch target instruction to the prefetch controller 73. In Step S204, the prefetch controller 73 starts the prefetch of the branch target instruction in response to the notice from the branch detector 16.

In Step S205, the instruction execution section 11 is supposed to execute the fetch of the branch target instruction from the instruction cache 14 in succession to the execution of the branch instruction in Step S202. However, because the prefetch of the branch target instruction is performed after the detection of the branch instruction in Step S203, the prefetch of the branch target instruction in Step S204 can be too late for the fetch of the branch target instruction by the instruction execution section 11 in Step S205. In such a case, the fetch of the branch target instruction in Step S205 is cache miss, which causes the instruction feed to the instruction execution section 11 to stop. The instruction execution section 11 needs to fetch and executes the branch target instruction after the branch target instruction is stored in the instruction cache 14, which leads to the suspension of the instruction feed to the instruction execution section 11 (Steps S205 and S206).

As a specific example of the suspension of the instruction feed to the instruction execution section 11 due to the presence of the branch instruction, the operation of retuning from the interrupt is described hereinafter. When the processing is branched from the normal to the interrupt, the value of the program counter 12, the value of the program status word (PSW), and the value of the registers to which the program is accessible are saved in order to enable the return to the original program after completing the interrupt. PSW is a collection of flags which indicate the program status, processor status and so on, which is stored in a register for PSW. FIG. 8A shows the instruction sequence for reconstituting the saved program counter value and so on before the interrupt when returning from the interrupt. FIG. 8B illustrates-a basic concept of the interrupt handling shown in FIG. 8.

The di instruction in the first row of FIG. 8A is the instruction for setting the flag indicating the interrupt enable/disable in PSW to the interrupt disable. The ld.w instruction in the second row is the instruction for reading the data of one word and storing it to the register. The mnemonic “ld.w0008[sp], r1” represents the instruction for reading data from the address that adds the displacement “0×0008” to the value of the stack pointer and stores the data to the register r1. This instruction causes the address of the return target instruction which is saved upon execution of the interrupt to be read to the general purpose register r1. The stack pointer “SP” indicates the address of the memory area (stack) where the program counter value and so on are temporarily saved, and the value of SP is stored in the general purpose register in the instruction execution section 11. In FIG. 8A, the register that stores the value of SP is indicated as “SP”.

The ldsr instruction in the third row of FIG. 8 is the load instruction to the system register. The mnemonic “ldsr r1, 00” represents the instruction for setting the contents of the general purpose register r1 to the system register 00 that is indicated by the system register number “00”. The system register 00 stores the instruction address of the return target from the interrupt, which corresponds to the branch target address register 17 described above.

The ld.w instruction in the fourth row and the ldsr instruction in the fifth row of FIG. 8A are the instructions for reading PSW before interrupt which is saved to the stack and storing the read PSW in the system register 01.

The ld.w instruction in the sixth row of FIG. 8A is the instruction for reading the stored value of the register r1 before the interrupt which is saved to the stack and storing it back to the register r1. The addi instruction in the seventh row is the arithmetical addition instruction for updating the value of the stack pointer SP.

The reti instruction in the eighth row of FIG. 8A is the instruction for directing the return from the interrupt. Specifically, the process updates the program counter 12 by the value of the system register 00 that corresponds to the branch target address register 17 and stores the return target instruction address and updates the PSW register by the value of the system register 01 that stores PSW of the return target. The status before the execution of the interrupt handling routine is thereby recovered. In this way, the reti instruction is one of the branch instructions because it updates the value of the program counter 12. The mov instruction in the ninth row is the instruction for copying between registers, which is an example of the instruction that is executed in the normal processing after returning from the interrupt.

FIG. 9 shows the timing when the instruction sequence of FIG. 8A is executed on the processor system 7 of the related art. The di instruction in the first row to the reti instruction in the rights row of FIG. 8A are the instructions during the interrupt and stored in the ROM 19. Therefore, these instructions are fetched from the ROM 19 and executed.

On the other hand, the mov instruction after the return is fetched from the instruction cache 14 and executed. As described in Steps S203 and S204 of FIG. 7, the prefetch of the mov instruction, which is the branch target instruction starts at the timing when the instruction execution section 11 fetches the reti instruction from the instruction cache 14 after the branch detector 16 detects the presence of the reti instruction. Thus, if the prefetch of the mov instruction is not completed before the fetch of the mov instruction by the instruction execution section 11 which occurs at the 10th clock, the fetch of the mov instruction results in the cache miss. Consequently, the feeding of the instruction to the instruction execution section 11 stops until the 12th clock when the mov instruction is stored in the instruction cache 14 by the access to the external memory 15.

As described in the foregoing, the conventional prefetch technology cannot start the prefetch of the branch target instruction until the branch instruction is detected at least in the predecoding after the instruction prefetch.

This drawback occurs not only in the prefetch to the instruction cache prior to the instruction fetch stage by the instruction execution section but occurs generally in the instruction prefetch in the processor system with the architecture which copies a part of the instruction sequence that is stored in a low-speed instruction storage area to an instruction buffer capable of high-speed reading.

### SUMMARY OF THE INVENTION

According to an aspect of the present invention, there is provided an instruction prefetch apparatus that prefetches an instruction from a memory prior to execution of an instruction, wherein an instruction is prefetched from the memory in dependence upon an instruction designating an address of a branch target instruction executed before branch instruction.

According to another aspect of the present invention, there is provided an instruction prefetch method that prefetches an instruction from a memory prior to execution of the instruction which includes prefetching an instruction from the memory in dependence upon an instruction designating an address of a branch target instruction executed before branch instruction.

This apparatus and method enable the start of the prefetch of a branch target instruction without depending on the detection of a branch instruction. This eliminates the need for waiting for the predecoding of a branch instruction, the result of branch prediction and so on, thereby allowing the prefetch of the branch target instruction to be performed at an earlier timing than the conventional way of starting the prefetch of the branch target instruction in response to the detection of the branch instruction.

The present invention provides the instruction prefetch apparatus and the instruction prefetch method capable of starting the prefetch of a branch target instruction without depending on the detection of a branch instruction.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a processor system according to an embodiment of the invention;

FIG. 2 is a view showing an operational flow of a processor system according to an embodiment of the invention;

FIG. 3 is a timing chart to describe the operation of a processor system according to an embodiment of the invention;

FIG. 4 is a block diagram of a processor system according to an embodiment of the invention;

FIG. 5 is a timing chart to describe the operation of a processor system according to an embodiment of the invention;

FIG. 6 is a block diagram of a processor system of a related art;

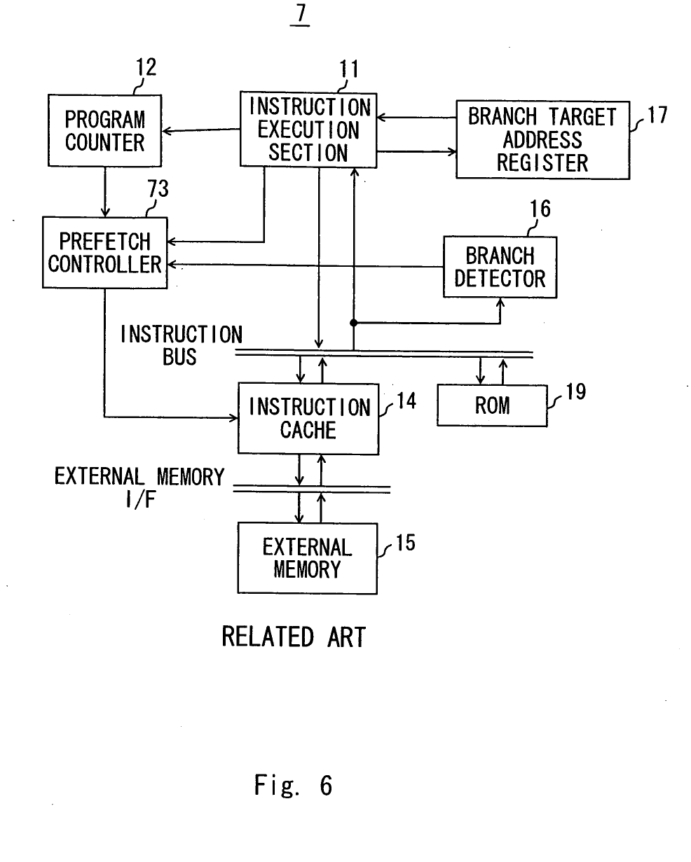

FIG. 7 is a view showing an operational flow of a processor system of a related art;

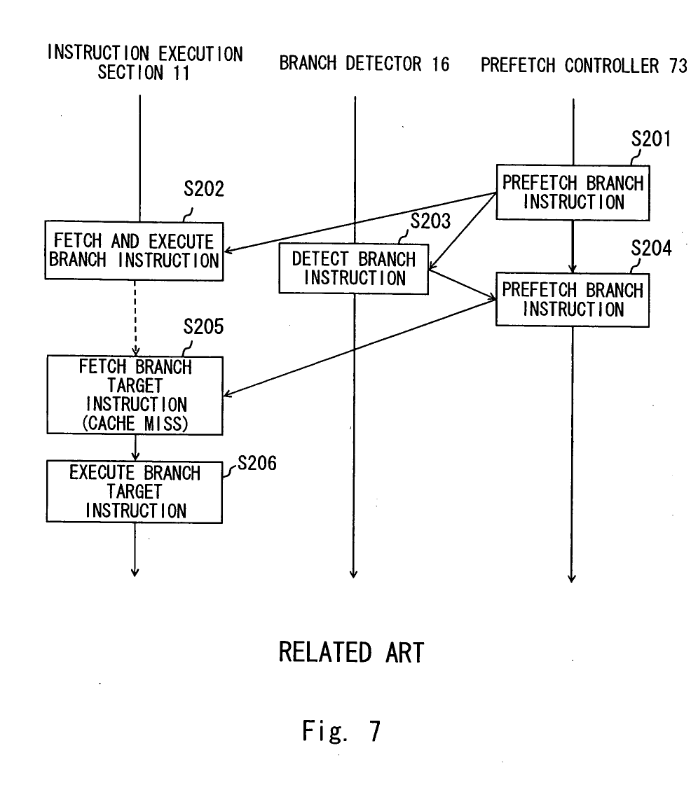

FIGS. 8A and 8B are views to describe interrupt return processing; and

FIG. 9 is a timing chart to describe the operation of a processor system of a related art.

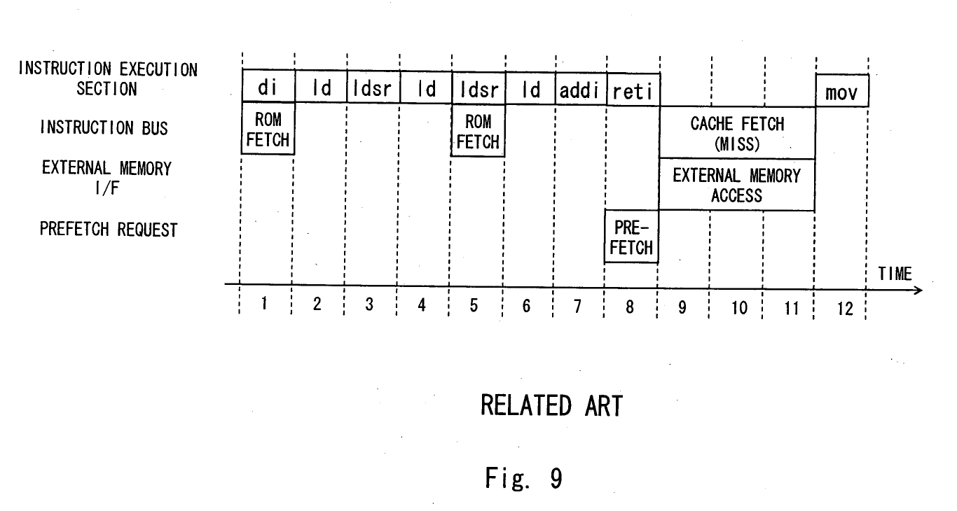

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

Exemplary embodiments of the present invention are described hereinafter in detail with reference to the drawings. The following embodiments describe the case where the present invention is applied to a processor system that includes an instruction cache and an instruction execution section to prefetch an instruction from an external memory to the instruction cache.

### First Embodiment

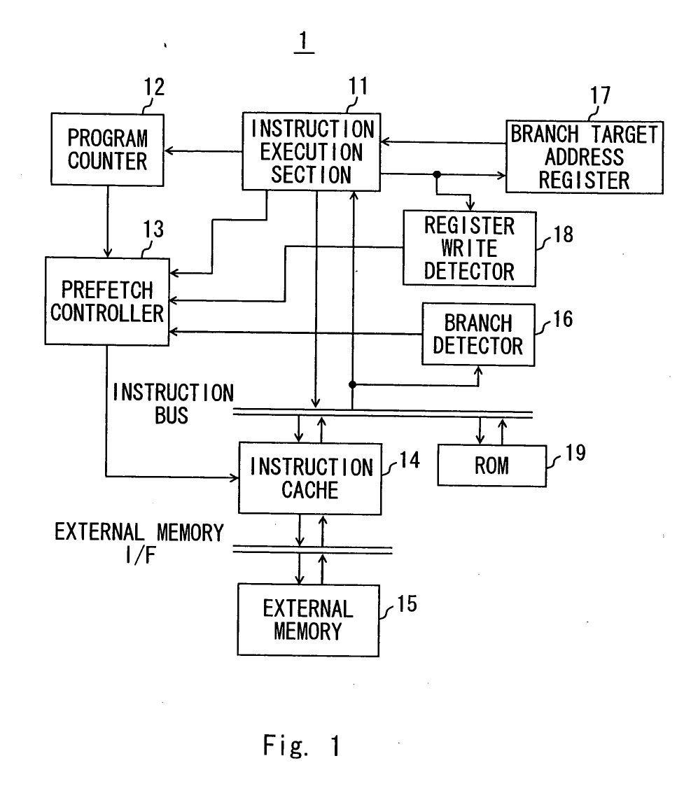

FIG. 1 shows the configuration of a processor system 1 according to an exemplary embodiment of the present invention. The processor system 1 includes the branch target address register 17, a register write detector 18 that detects the writing to the branch target address register 17, and a prefetch controller 13 that performs the instruction prefetch according to the detection result of the register write detector 18. The instruction execution section 11, program counter 12, external memory 15, branch detector 16, branch target address register 17 and ROM 19 in the processor system 1 are the same as those in the processor system 7 described above and denoted by the same reference numerals, and not described in detail herein.

The register write detector 18 detects the writing to the branch target address register 17 by the instruction execution section 11 and notices the detected address value to the prefetch controller 13. The prefetch controller 13 prefetches the branch target instruction using the address value noticed from the register write detector 18. Instead, the register write detector 18 may notices the detection of the writing to the branch target address register 17 to the prefetch controller 13, and, receiving the notice, the prefetch controller 13 may refers to the branch target address register 17 to obtain the address to be prefetched. The point is to allow the prefetch controller 13 to obtain the branch target instruction address in response to the writing to the branch target address register 17.

As described above, the branch target address register 17 includes (1) a register that stores the address of a return target instruction when returning from interrupt or exception handling, (2) a register that stores the entry address of the task which is dispatched by the multitasking OS, (3) a register which is specified by a compiler as a base register in designating the branch target instruction address by register indirect addressing when returning from software interrupt, calling the function, returning from the function, and so on. All or a part of these registers may be a detection target by the register write detector 18.

In this way, the processor system 1 of this embodiment starts the prefetch of the branch target instruction in accordance with the setting of the branch target instruction address to the branch target address register 17 which occurs prior to the execution of the branch instruction, focusing on the fact that the branch target address register 17 which stores the branch target instruction is designated in the operand of the branch instruction by register indirect addressing.

Specifically, the register write detector 18 detects that the branch target instruction address is set to the branch target address register 17 prior to the execution of the branch instruction. This triggers the prefetch controller 13 to start the prefetch of the branch target instruction. This operation enables the prefetch of the branch target instruction without depending on the detection of the branch instruction by the branch detector 16.

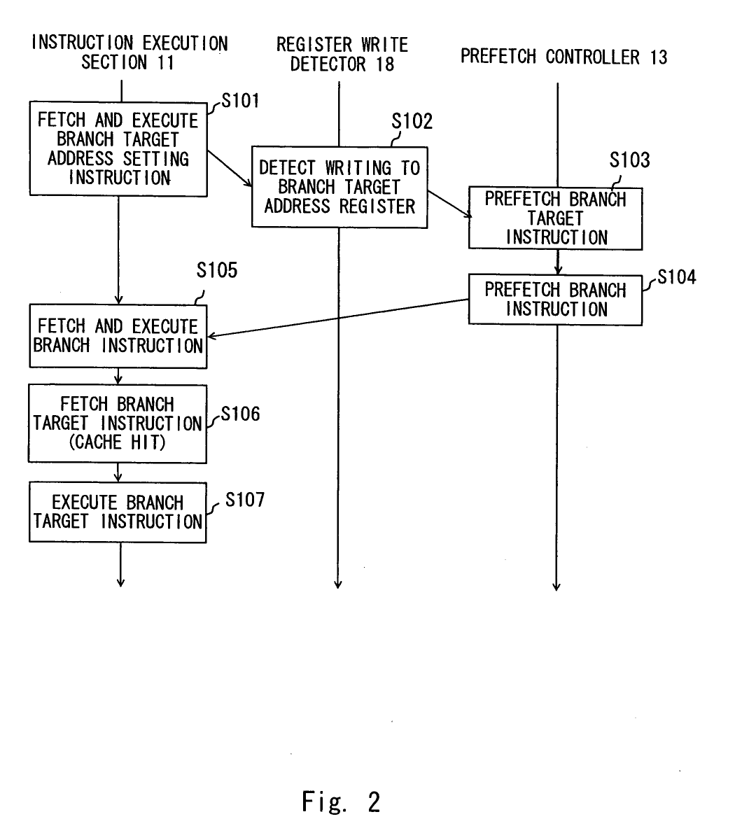

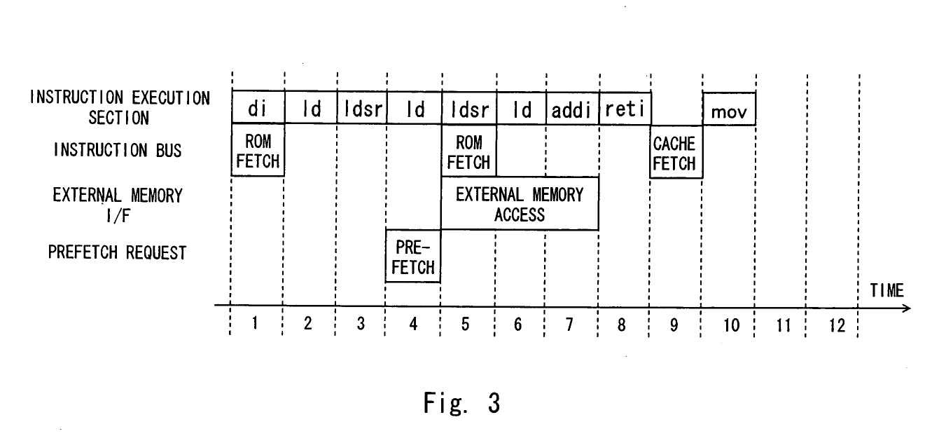

Referring then to FIGS. 2 and 3, the prefetch of the branch target instruction in the processor system 1 is described hereinafter in detail. FIG. 2 shows the operational timing when the instruction execution section 11 executes the branch instruction which are represented in the form of a flowchart including the relationship with the register write detector 18 and the prefetch controller 13.

First, in Step S101, the instruction execution section 11 executes the instruction for storing the branch target instruction address into the branch target address register 17. In Step S102, the register write detector 18 detects the writing to the branch target address register 17 by the instruction execution section 11 and notices the branch target instruction address, which is the stored value into the register, to the prefetch controller 13. In Step S103, the prefetch controller 13 starts the prefetch of the branch target instruction in response to the notice from the register write detector 18,

In Step S104, the prefetch controller 13 prefetches the branch instruction in accordance with the value of the program counter 12. In Step S105, the instruction execution section 11 executes the branch instruction fetched from the instruction cache 14 and updates the program counter 12 by the branch target instruction address. In Step S106, the instruction execution section 11 fetches the branch target instruction from the instruction cache 14. Finally, in Step S107, the instruction execution section 11 executes the branch target instruction without delay.

In this way, the processor system 1 starts the prefetch of the branch target instruction instantaneously in response to the setting of the branch target instruction address in Step S103 and executes the refill of the branch target instruction to the instruction cache 14. Therefore, the fetch of the branch target instruction performed in Step S106 is likely to result in cache hit, enabling the feeding of the branch target instruction to the instruction execution section 11 without delay.

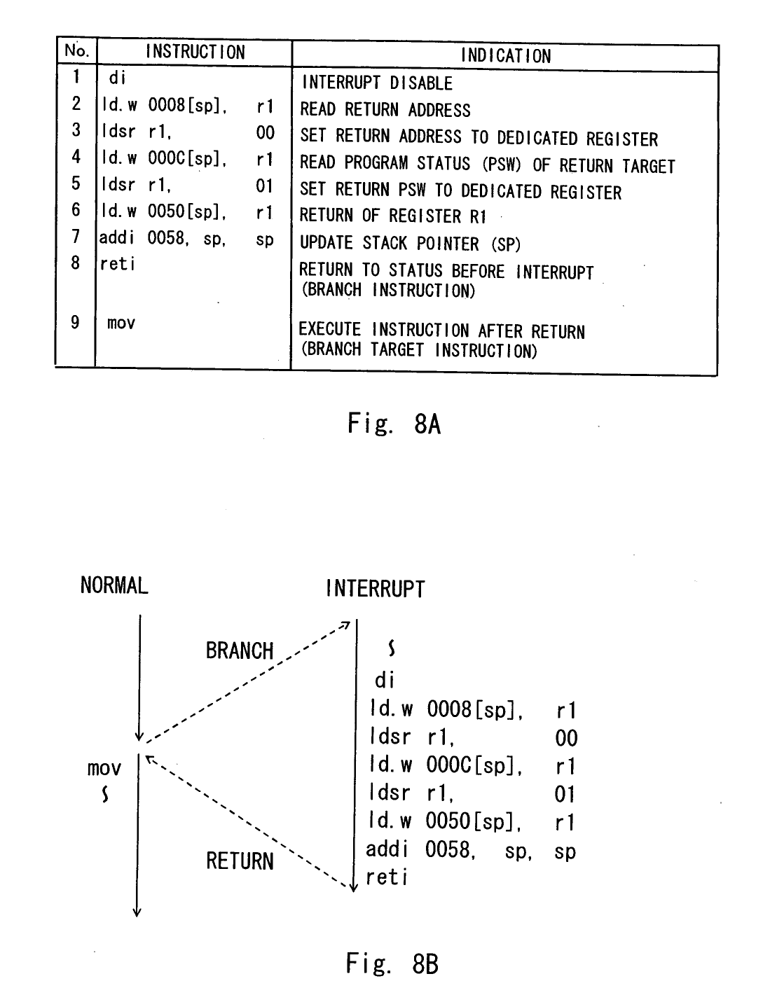

Referring now to FIG. 3, the operation when returning from the interrupt is described hereinafter as a specific example of the branch instruction. FIG. 3 is a timing chart where the processor system 1 executes the instruction sequence when returning from the interrupt shown in FIG. 8A. As described earlier, the ldsr instruction in the third row of FIG. 8A corresponds to the instruction for storing the branch target instruction address to the branch target address register 17. Therefore, the register write detector 18 detects the writing to the system register 00 which occurs as a result of the execution of the ldsr instruction in the third row of FIG. 8A and notices the stored value to the prefetch controller 13. This allows the prefetch of the mov instruction (branch target instruction) of the return target prior to the following detection of the reti instruction (branch instruction).

Specifically, after the execution of the ldsr instruction at the 3rd clock in FIG. 3, the prefetch is requested by the prefetch controller 13, and the area including the address of the mov instruction, which is the branch target instruction, is refilled from the external memory 15 to the instruction cache 14. Therefore, the instruction fetch in response to the mov instruction of the branch target which occurs at the 9th clock is likely to result in cache hit. It is thereby possible to execute the mov instruction after the return from the interrupt without delay.

It is possible to start the prefetch of the branch target instruction by detecting the writing to the branch target address register 17 not only when returning from the interrupt but also when executing other branch instructions such as the execution of conditional branch instruction, task dispatching by a multitasking OS and so on.

As described in the foregoing, the processor system 1 of this embodiment focuses on the fact that the processing to store the branch target instruction address to a memory area such as a register is executed before the execution of the branch instruction, and starts the prefetch of the branch target instruction upon occurrence of the processing to store the branch target instruction address. This enables starting the prefetch of the branch target instruction in accordance with the processing that is performed prior to the branch instruction without depending on the detection of the branch instruction. The processor system 1 can thereby start the prefetch of the branch target instruction earlier than the conventional processor system 7 which starts the prefetch of the branch target instruction in response to the detection of the branch instruction.

The processing of designating the branch target instruction address prior to the branch instruction is performed in conventional program. Therefore, the advantage of the present invention can be achieved without altering the conventional program and compiler that creates the program.

When the alternation of the program is allowed, it is preferred that the compiler creates the program so as to execute the instruction for setting the branch target instruction address to the branch target address register 17 (referred to herein as the branch target address setting instruction), which is executed separately from the branch instruction, well before the execution of the branch target instruction. This enables flexibly securing the time that is required for the prefetch of the branch target instruction.

### Second Embodiment

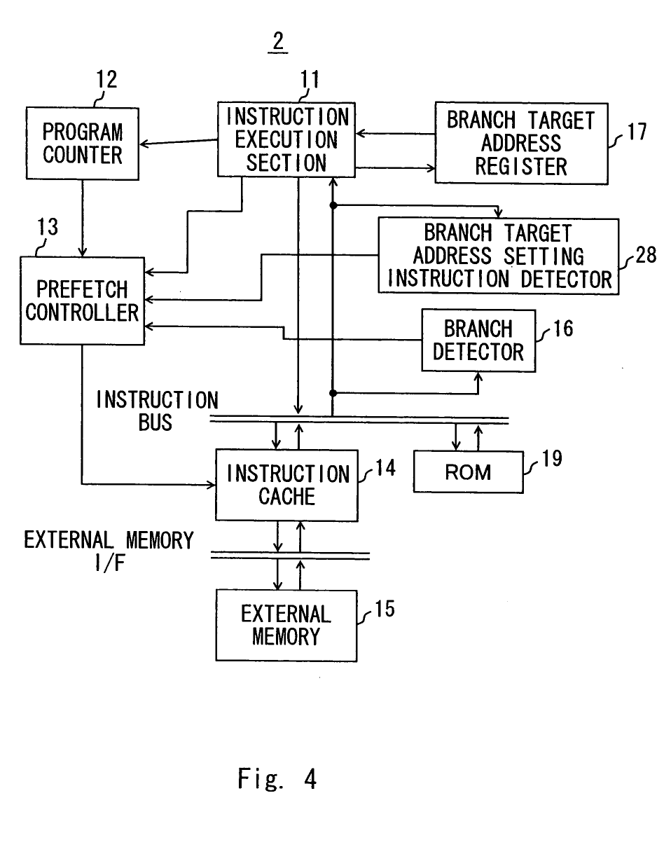

FIG. 4 shows the configuration of a processor system 2 according to another exemplary embodiment of the present invention. The processor system 2 has a branch target address setting instruction detector 28 instead of the register write detector 18 which is included in the processor system 1 as described above. The branch target address setting instruction detector 28 detects that the instruction execution section 11 fetches the branch target address setting instruction and directs the prefetch controller 13 to start the prefetch of the branch target instruction.

The processor system 2 can start the prefetch of the branch target instruction earlier than the processor system 1 that detects the writing to the branch target address register 17 which occurs in the register write detector 18 as a result of the execution of the branch target address setting instruction.

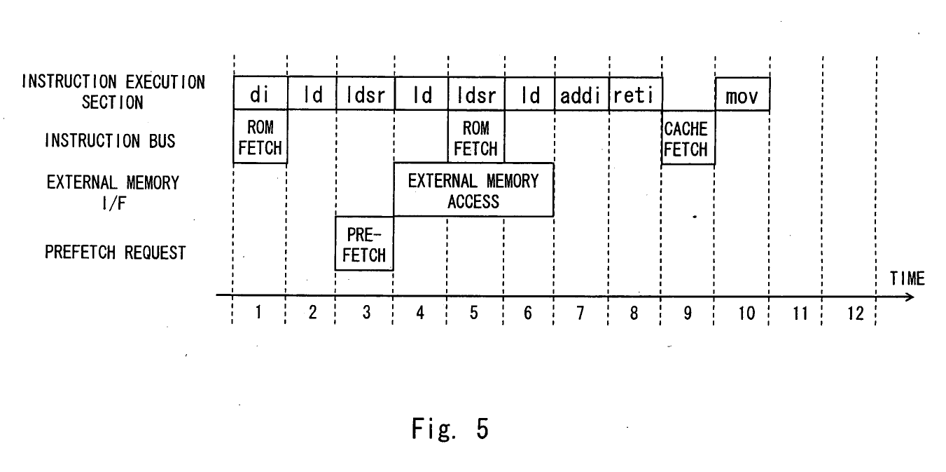

FIG. 5 is a timing chart where the processor system 2 executes the processing of the return from the interrupt shown in FIG. 8A. As described in FIG. 5, the processor system 2 can make the request for the prefetch of the branch target instruction upon detection of the ldsr instruction at the 3rd clock, which is the branch target address setting instruction, thus capable of starting the prefetch of the branch target instruction instantaneously.

The above embodiments describe the case of applying the present invention to the processor system that executes the instruction prefetch from the external memory to the instruction cache. However, the application of this invention is not limited thereto. The present invention focuses on the fact that the processing to designate the branch target address is executed before the execution of the branch instruction, and starts the prefetch of the branch target instruction upon occurrence of the processing to designate the branch target address. Thus, this invention is applicable not only to the prefetch control apparatus that prefetches the instruction from the main memory to the cache memory as described in the first and second embodiments but is widely applicable to the configuration that prefetches an instruction to a primary storage area (instruction buffer) prior to the execution of the instruction.

It is apparent that the present invention is not limited to the above embodiment that may be modified and changed without departing from the scope and spirit of the invention.

What is claimed is:

1. An instruction prefetch apparatus that prefetches an instruction from a memory prior to execution of an instruction, wherein
an instruction is prefetched from the memory in dependence upon an instruction designating an address of a branch target instruction executed before branch instruction.

2. The, instruction prefetch apparatus according to claim 1, comprising:
a branch target address storage for storing the address of the branch target instruction, wherein
the instruction address stored in the branch target address storage is prefetched by detecting writing to the branch target address storage.

3. The instruction prefetch apparatus according to claim 1, comprising:
an instruction buffer for storing a prefetched instruction;
an instruction execution section for reading and executing an instruction stored in the instruction buffer;
a branch target address storage for storing the address of the branch target instruction; and
a prefetch controller for prefetching the branch target instruction in dependence upon writing to the branch target address storage.

4. The instruction prefetch apparatus according to claim 3, wherein the prefetch controller prefetches an instruction address stored in the branch target address storage by detecting writing to the branch target address storage.

5. The instruction prefetch apparatus according to claim 3, wherein the branch target address storage is a register for storing an instruction address of a return target when the instruction execution section returns from interrupt or exception handling.

6. The instruction prefetch apparatus according to claim 3, wherein the branch target address storage is a register for storing an instruction address of a switch target task when an execution task in the instruction execution section is switched.

7. The instruction prefetch apparatus according to claim 1, comprising:
an instruction buffer for storing a prefetched instruction;
an instruction execution section for reading and executing an instruction stored in the instruction buffer;
a branch target address storage for storing the address of the branch target instruction;
a branch target address setting instruction detector for detecting fetch of write instruction to the branch target address storage; and
a prefetch controller for starting prefetch of the branch target instruction in response to a detection result by the branch target address setting instruction detector.

8. An instruction prefetch method that prefetches an instruction from a memory prior to execution of the instruction, comprising:
prefetching an instruction from the memory in dependence upon an instruction designating an address of a branch target instruction executed before branch instruction.

9. The instruction prefetch method according to claim 8, comprising:
detecting writing to a branch target address storage for storing the address of the branch target instruction, and
prefetching the instruction address stored in the branch target address storage.

10. The instruction prefetch method according to claim 9, wherein the branch target address storage is a register for storing an instruction address of a return target when returning from interrupt or exception handling.

11. The instruction prefetch method according to claim 9, wherein the branch target address storage is a register for storing an instruction address of a switch target task when an execution task is switched.

12. A processor system that prefetches an instruction from a memory prior to execution of the instruction, wherein
an instruction is prefetched from the memory in dependence upon an instruction designating an address of a branch target instruction executed before branch instruction.

13. The processor system according to claim 12, comprising:
a branch target address storage for storing the address of the branch target instruction, wherein
writing to the branch target address storage is detected, and an instruction address stored in the branch target address storage is prefetched.

14. The processor system according to claim 12, comprising:
an instruction buffer for storing a prefetched instruction;
an instruction execution section for executing an instruction stored in the instruction buffer;
a branch target address storage for storing the address of the branch target instruction; and
a prefetch controller for prefetching the branch target instruction in dependence upon writing to the branch target address storage by the instruction execution section.

15. The processor system according to claim 14, wherein the prefetch controller prefetches the instruction address stored in the branch target address storage by detecting writing to the branch target address storage by the instruction execution section.

16. The processor system according to claim 14, wherein the branch target address storage is a register for storing an instruction address of a return target when the instruction execution section returns from interrupt or exception handling.

17. The processor system according to claim 14, wherein the branch target address storage is a register for storing an instruction address of a switch target task when an execution task in the instruction execution section is switched.

18. The processor system according to claim 12, comprising:
an instruction buffer for storing a prefetched instruction;
an instruction execution section for reading and executing an instruction stored in the instruction buffer;
a branch target address storage for storing the address of the branch target instruction;
a branch target address setting instruction detector for detecting fetch of a write instruction to the branch target address storage by the instruction execution section; and
a prefetch controller for starting prefetch of the branch target instruction in response to a detection result of the branch target address setting instruction detector.
